(19) United States
(12) Patent Application Publication
(10) Pub. No.: US 2011/0051428 A1
(43) Pub. Date: Mar. 3, 2011

(54) LED LIGHT ENGINE WITH MULTI-PATH HEAT DISSIPATION

(75) Inventors: Yang Liu, Shatin (HK); De Liang Ding, Shatin (HK); MIng Lu, Sijhih City (TW)

(73) Assignee: Hong Kong Applied Science and Technology Research Institute Co. Ltd., Shatin (HK)

(21) Appl. No.: 12/553,531

(22) Filed: Sep. 3, 2009

(51) Int. Cl. F21V 21/00; F21V 29/00

(52) U.S. Cl. 362/368; 362/373

(57) ABSTRACT

A light emitting diode (LED) light engine is provided. According to one embodiment of the invention, the LED light engine includes a housing; an LED mounting board secured within the housing, the LED mounting board including one or more LED electrically connected to the LED mounting board, the LED mounting board configured to receive power from a power source to power the one or more LED; and a heat bridge conductively coupling the LED mounting board to the housing, wherein the heat bridge is configured to conduct heat from the LED mounting board to the housing, wherein the housing is configured to dissipate heat. The heat bridge may take one of several different configurations. A lighting assembly may be provided for securely mounting one or more LED light engines.

### FIELD OF THE INVENTION

The present invention relates to a light emitting diode (LED) lighting devices, and more particularly, to a LED light engine with multi-path heat dissipation.

### BACKGROUND OF THE INVENTION

Light emitting diode (LED) technology is currently one of the most innovative and fastest growing in the lighting industry. While LED have been in use for decades for indicator and signaling purposes, technology developments and improvements have allowed for a broader use. The use of LED in lighting applications has grown especially rapidly in recent years.

The use of LED in lighting applications is attractive for a number of reasons, including the ability to provide higher levels of illumination, a longer life cycle, minimum maintenance requirements, energy efficient, and flexibility in terms of coloring and beam control.

LED generate a generally high level of heat during operation. It is also known that changes in the temperature of the p-n junction of an LED (“the junction temperature”) can affect the performance of the LED. Efforts to control the temperature of LED have been made. However, previous efforts have failed to address certain applications or configurations. Using LED in outdoor lighting has proven to be particularly problematic since, for example, it is useful for the lighting assembly to be protected from water and dust. However, any kind of sealing of the lighting assembly may result in limited air ventilation, thereby limiting heat dissipation and increasing the operating temperature of the lighting assembly. Poor heat dissipation may therefore result in a short lifetime of the lighting assembly and poor luminary efficiency.

Accordingly, there is a need for a lighting assembly and an LED light engine with multi-path heat dissipation that addresses these and other shortcomings of LED lighting.

### SUMMARY OF THE INVENTION

According to one embodiment of the present invention, a light emitting diode (LED) light engine is disclosed. The LED engine includes a housing; an LED mounting board secured within the housing, the LED mounting board including one or more LED electrically connected to the LED mounting board, the LED mounting board configured to receive power from a power source to power the one or more LED; and a heat bridge conductively coupling the LED mounting board to the housing, wherein the heat bridge is configured to conduct heat from the LED mounting board to the housing, wherein the housing is configured to dissipate heat.

According to another embodiment of the present invention, an LED lighting assembly is disclosed. The LED lighting assembly includes a lighting assembly housing; a mounting frame secured within the lighting assembly housing; and multiple LED light engines movably secured to the mounting frame, each of the multiple LED light engines including a housing; an LED mounting board secured within the housing, the LED mounting board including one or more LED electrically connected to the LED mounting board, the LED mounting board configured to receive power from a power source to power the one or more LED; and a heat bridge conductively coupling the LED mounting board to the housing, wherein the heat bridge is configured to conduct heat from the LED mounting board to the housing, wherein the housing is configured to dissipate heat.

Still other embodiments of the present invention will become readily apparent to those skilled in the art from the following detailed description, wherein embodiments of the invention are described by way of illustration. As will be realized, the invention is capable of other and different embodiments and its several details are capable of modifications in various respects, all without departing from the spirit and the scope of the present invention.

### BRIEF DESCRIPTION OF THE DRAWINGS

FIG. 1 is a front perspective view of a lighting assembly 100, in accordance with an embodiment of the present invention.

FIG. 2 is an exploded view of the lighting assembly shown in FIG. 1, in accordance with an embodiment of the present invention.

FIG. 3 is an exploded view of the mounting frame shown in FIG. 2, in accordance with an embodiment of the present invention.

FIG. 4 is a top perspective view of a light engine, in accordance with a first embodiment of the present invention.

FIG. 5 is an exploded view of a light engine, in accordance with an embodiment of the present invention.

FIG. 6 is a top view of the light engine shown in FIG. 4, in accordance with an embodiment of the present invention.

FIG. 7 is a side cross sectional view of the light engine shown in FIG. 4, in accordance with an embodiment of the present invention.

FIG. 8 is bottom view of the light engine shown in FIG. 4, in accordance with an embodiment of the present invention.

FIG. 9 is a side view of the light engine shown in FIG. 4, in accordance with a third embodiment of the present invention.

FIG. 10 is an end cross sectional view of the light engine shown in FIG. 4, in accordance with an embodiment of the present invention.

FIG. 11 is a top view of a light engine, in accordance with a second embodiment of the present invention.

FIG. 12 is bottom view of the light engine shown in FIG. 11, in accordance with an embodiment of the present invention.

FIG. 13 is a side view of the light engine shown in FIG. 11, in accordance with an embodiment of the present invention.

FIG. 14 is an end cross sectional view of the light engine shown in FIG. 11, in accordance with an embodiment of the present invention.

FIG. 15 is a side cross sectional view of the light engine shown in FIG. 11, in accordance with an embodiment of the present invention.

FIG. 16 is an end cross sectional view of a light engine, in accordance with a third embodiment of the present invention.

FIG. 17 is a side cross sectional view of the light engine shown in FIG. 16, in accordance with an embodiment of the present invention.

FIG. 18 is an end cross sectional view of a light engine, in accordance with a fourth embodiment of the present invention.

FIG. 19 is a side cross sectional view of the light engine shown in FIG. 18, in accordance with an embodiment of the present invention.

FIG. 20 is an end cross sectional view of a light engine, in accordance with a fifth embodiment of the present invention.

FIG. 21 is a side cross sectional view of the light engine shown in FIG. 20, in accordance with an embodiment of the present invention.

FIG. 22 is an end cross sectional view of a light engine, in accordance with a sixth embodiment of the present invention.

FIG. 23 is a side cross sectional view of the light engine shown in FIG. 22, in accordance with an embodiment of the present invention.

FIG. 24 is an end cross sectional view of a light engine, in accordance with a seventh embodiment of the present invention.

FIG. 25 is a side cross sectional view of the light engine shown in FIG. 24, in accordance with an embodiment of the present invention.

FIG. 26 is an end cross sectional view of a light engine, in accordance with an eighth embodiment of the present invention.

FIG. 27 is a side cross sectional view of the light engine shown in FIG. 26, in accordance with an embodiment of the present invention.

FIG. 28 is an end cross sectional view of a light engine, in accordance with a ninth embodiment of the present invention.

FIG. 29 is a side cross sectional view of the light engine shown in FIG. 28, in accordance with an embodiment of the present invention.

FIG. 30 is an end cross sectional view of a light engine, in accordance with a tenth embodiment of the present invention.

FIG. 31 is a side cross sectional view of the light engine shown in FIG. 30, in accordance with an embodiment of the present invention.

### DETAILED DESCRIPTION

In the following description, reference is made to the accompanying drawings where, by way of illustration, specific embodiments of the invention are shown. It is to be understood that other embodiments may be used as structural and other changes may be made without departing from the scope of the present invention. Also, the various embodiments and aspects from each of the various embodiments may be used in any suitable combinations. Accordingly, the drawings and detailed description are to be regarded as illustrative in nature and not as restrictive.

Generally, embodiments of the present invention are directed to an LED light engine with multi-path heat dissipation and a lighting assembly that provides for thermal management and heat dissipation. Embodiments of the present invention may be used for outdoor lighting, such as a streetlamp, floodlight, or other outdoor light. Embodiments of the present invention may also be used for indoor lighting or any desired lighting devices. The lighting assembly includes multiple LED light engines for generating light.

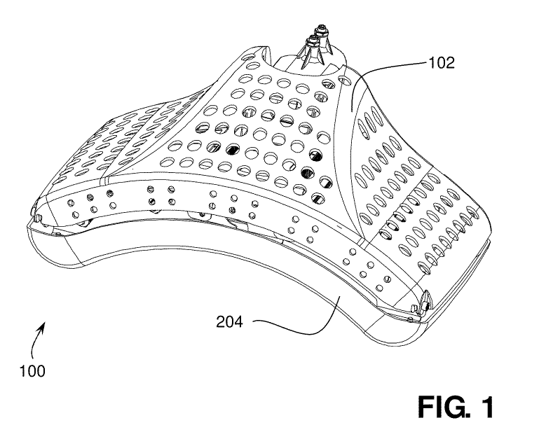

Referring now to the figures, FIG. 1 is a front perspective view of a lighting assembly 100, in accordance with an embodiment of the present invention. The lighting assembly 100 includes a top cover 102 and a bottom cover 204 to protect the internal structure of the lighting assembly 100. The holes on top cover 102 of various sizes may facilitate the air flow into and through the inside of the lighting assembly, which benefits heat dissipation.

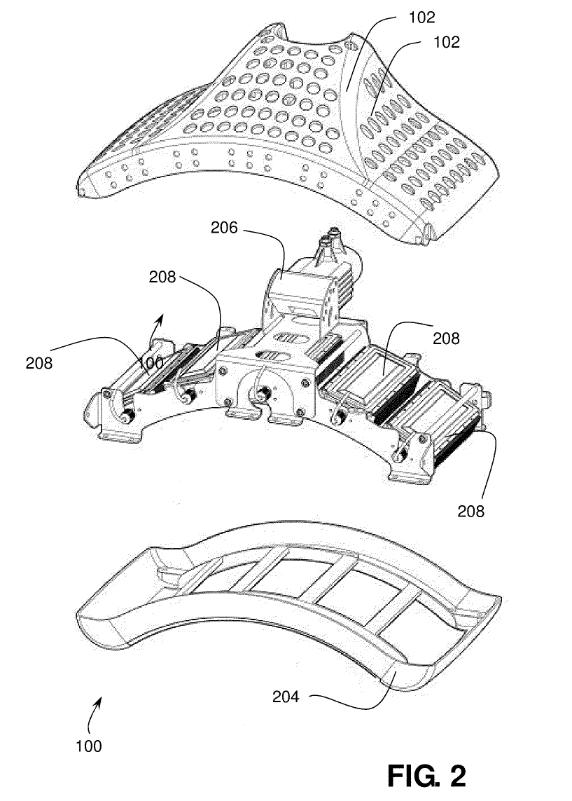

FIG. 2 is an exploded view of the lighting assembly shown in FIG. 1, in accordance with an embodiment of the present invention. The lighting assembly 100 includes the top cover 102, the bottom cover 204 and a mounting frame 206. The mounting frame 206 includes multiple LED light engines 208. While the illustrated embodiment includes five light engines 208, embodiments of the present invention may include any number of light engines 208. The shape of top cover 102 and bottom cover 204 is not limited to the one shown in the illustrated embodiment. For example, the shape can be curved down or up and occupy any suitable shape to accommodate the LED light engines. The top cover 102 and the bottom cover 204 are joined around the mounting frame 206, forming the lighting assembly 100 with the light engines 208 enclosed within the top cover 102 and the bottom cover 204.

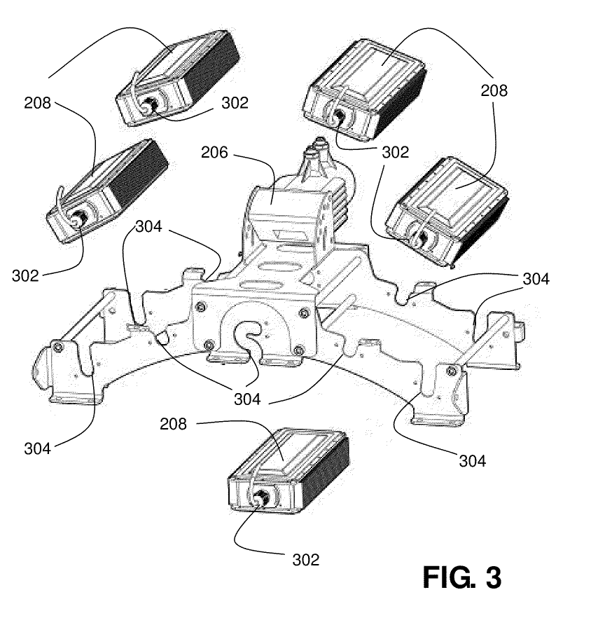

FIG. 3 is an exploded view of the mounting frame shown in FIG. 2, in accordance with an embodiment of the present invention. The light engines 208 are shown removed from the mounting frame 206. Each of the light engines 208 includes a set of mounting pins 302, one at each end of the light engines 208. Mounting slots 304 are defined in the mounting frame 206. The position and size of the mounting slots 304 are configured to receive the mounting pins 302 of each of the light engines 208. Each of the light engines 208 may be pivotable within the mounting frame 206 and individually adjustable in order to direct light in desired directions.

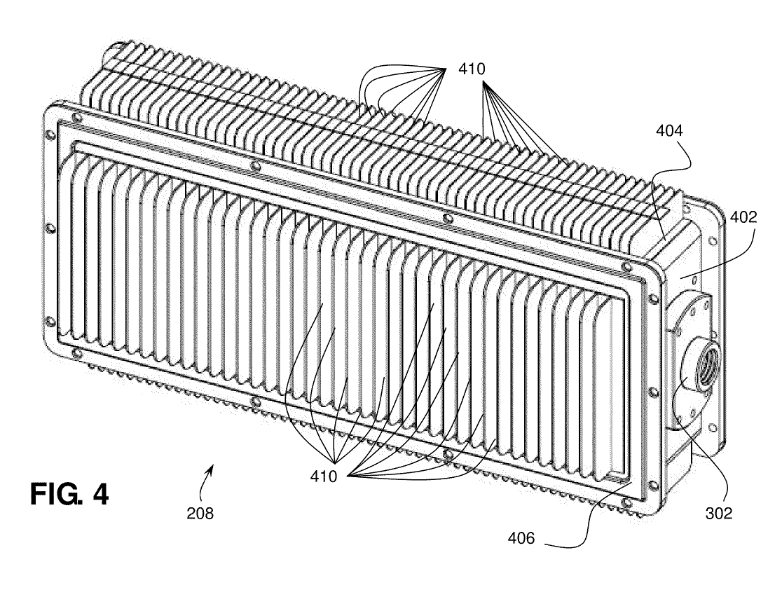

Referring now to FIGS. 4 to 10, a light engine is illustrated and described, in accordance with a first embodiment of the present invention. FIG. 4 is a top perspective view of the light engine 208. Each of the light engines 208 include a housing 402, side panels 404, a top panel 406, and a lower panel 408. In the illustrated embodiment, the lower panel 408 is a glass panel to permit the light from the LEDs to be admitted from the light engine 208. The side panels 404 and the top panel 406 include multiple heat dissipation fins 410.

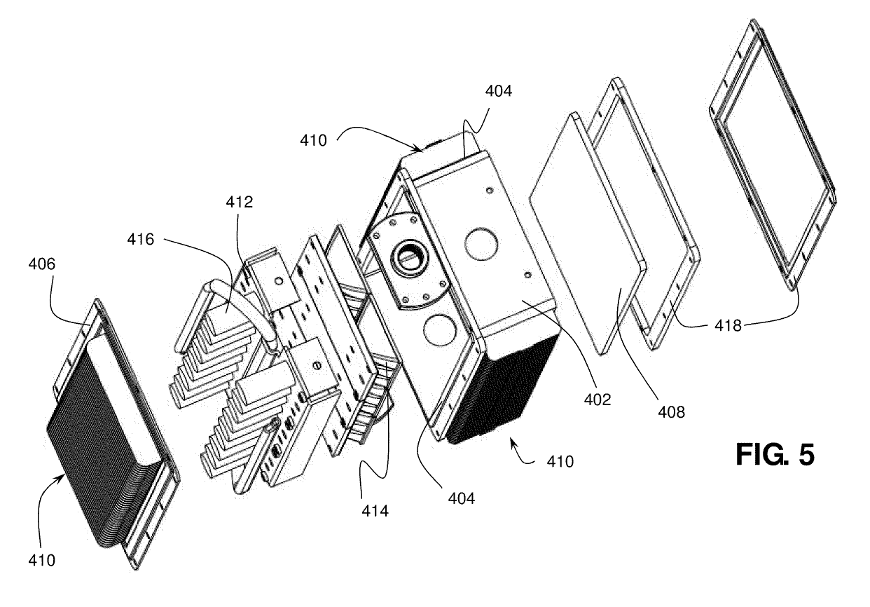

Referring now to FIG. 5, an exploded view of a light engine is shown and described. A mounting board 412 is provided within the housing 402 with multiple LED at fixed to the mounting board 412. An optical reflector 414 may also be provided proximate to or abutting the mounting board 412 to modify the light output distribution of the LEDs. A heat bridge 416 maybe provided within the housing 402 to act as bridge between the mounting board 412 to the top panel 406. The heat bridge 416 maybe configured to transfer heat from the mounting board 412 to the back panel 406 for increase heat dissipation. Panel frames 418 maybe provided help secure the front panel 408 to housing 402. The internal structure shown in FIG. 5 is one example embodiment according to the present invention. Specifically, the heat bridge 416 and internal components may occupy other configurations different from that shown in FIG. 5.

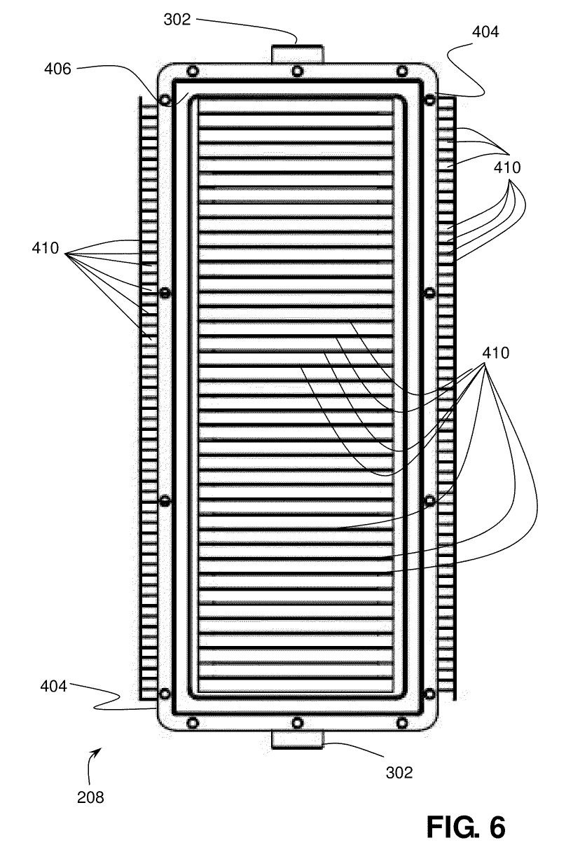

FIG. 6 is a top view of the light engine shown in FIG. 4, in accordance with an embodiment of the present invention. In FIG. 6, the heat dissipation fins 410 of the back panel 406 and the heat dissipation fins 410 of the side panels 404 may be seen. The mounting pins 302 are also shown in FIG. 6.

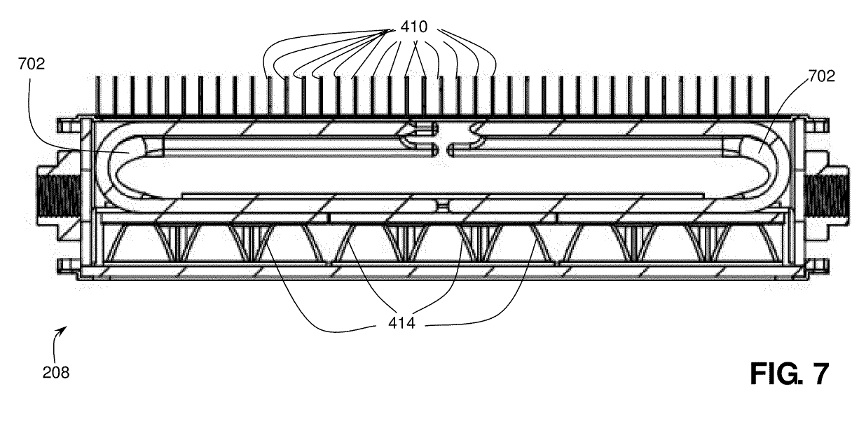

FIG. 7 is a side cross sectional view of the light engine shown in FIG. 4, in accordance with a second embodiment of the present invention. Different from the embodiment illustrated and described with reference to FIG. 5, the heat bridge includes heat conduction pipes 702 in FIG. 7. A first end of the heat conduction pipes 702 is connected to the mounting board 412, and a second end of the heat conduction pipes 702 is connected to one of the panels, either the side panels 404 or the top Panel 406. Each of the heat conduction pipes 702 serves to transfer heat from the mounting board 412 to the one of the panels.

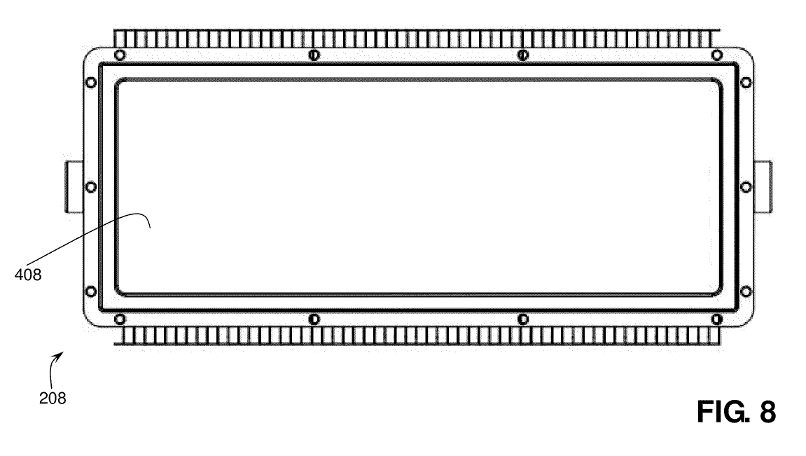

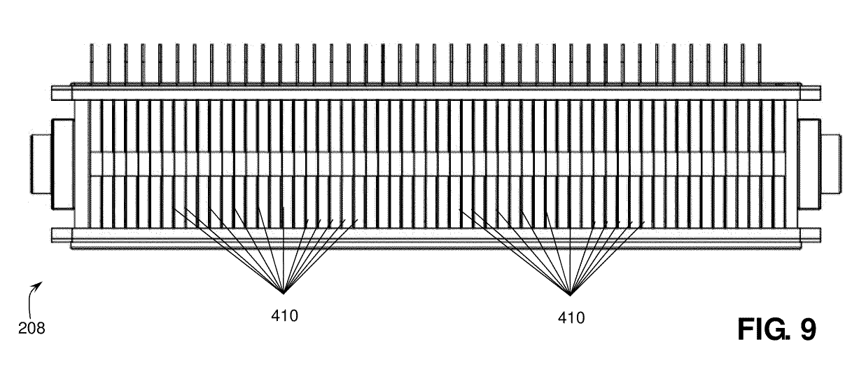

FIG. 8 is bottom view of the light engine shown in FIG. 4 and FIG. 9 is a side view of the light engine shown in FIG. 4, in accordance with an embodiment of the present invention. The lower panel 408, the heat dissipation fins 41 0, and the mounting pins 402 may be seen in FIG. 8.

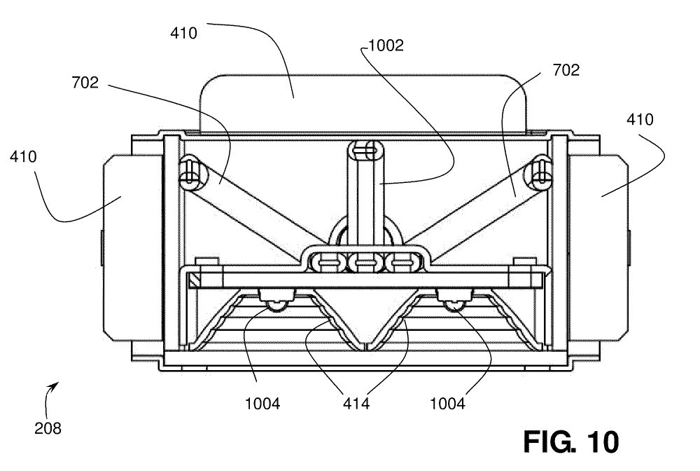

FIG. 10 is an end cross sectional view of the light engine shown in FIG. 7, in accordance with an embodiment of the present invention. The side heat conduction pipes 702 may be clearly seen joining the mounting board 412 to each of the side panels 404. A top heat conduction pipe 1002 joins the mounting board 412 to the top panel 406. LED 1004 are coupled to the mounting board 412, each of the LED positioned within the optical reflector 414.

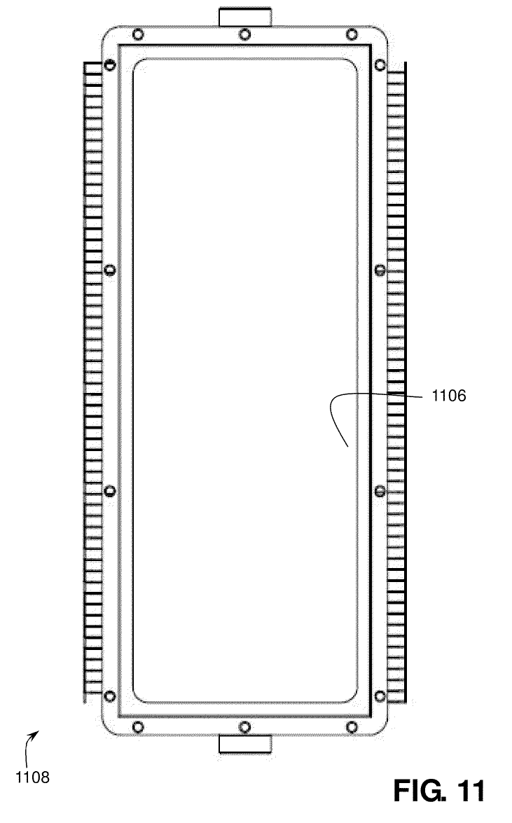

In the figures, unless otherwise identified, like elements of the light engines shown with reference to FIGS. 11 to 31 are considered to be similar to those illustrated and described with reference to the first embodiment of the light engine. Therefore, for the purpose of clarity, not all elements of the additional embodiments of the light engine are referenced in FIGS. 11 to 31.

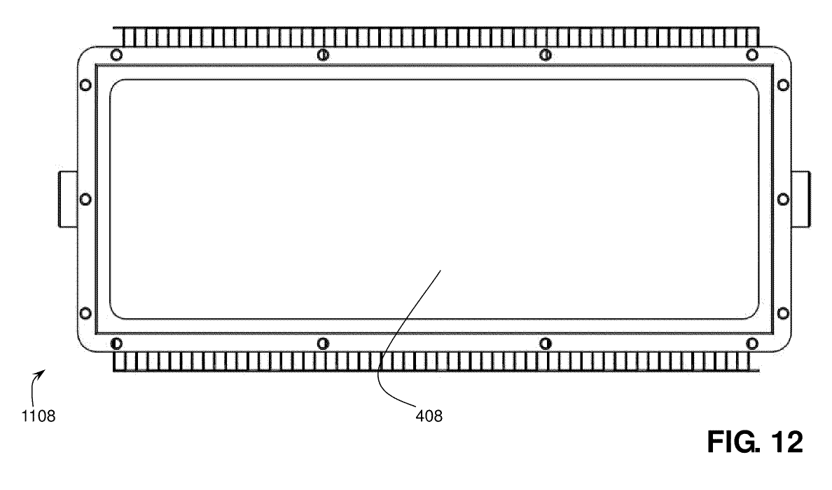

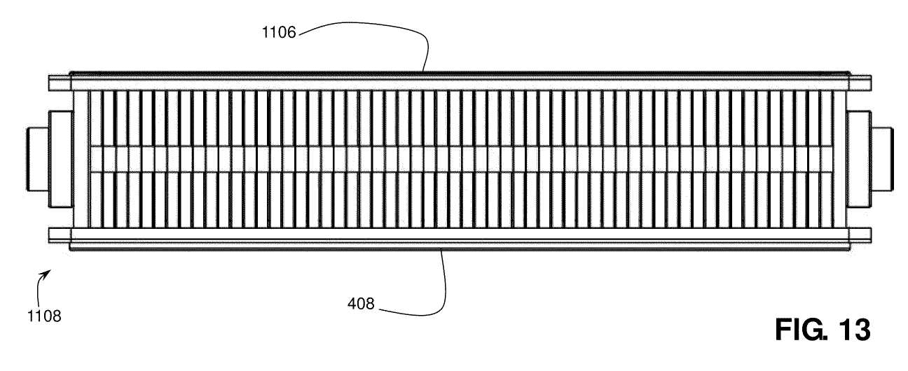

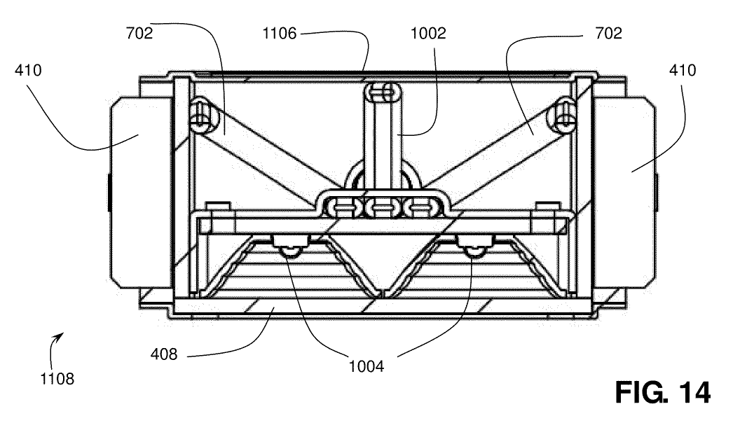

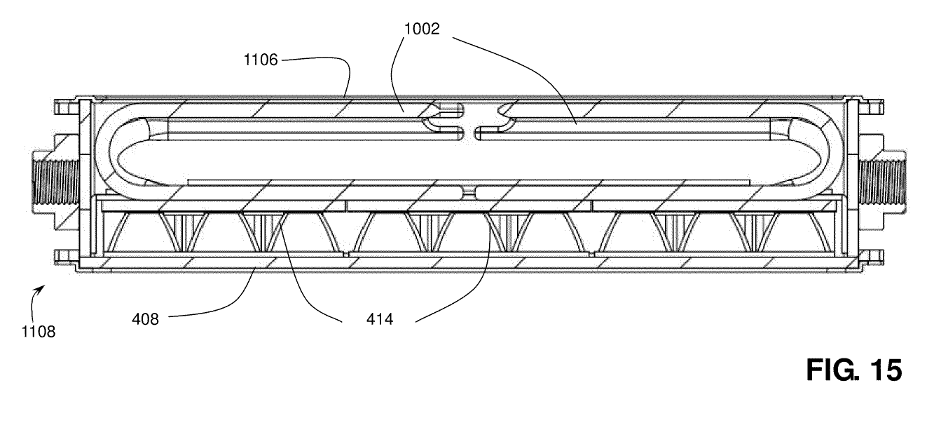

Referring to FIGS. 11 to 15, a second embodiment of a light engine is illustrated and described. FIG. 11 is a top view of the second embodiment of the light engine 1108, in accordance with an embodiment of the present invention. In the second embodiment of the light engine, the top panel 1106 is a heat sink, without heat dissipation fins. FIG. 12 is bottom view of the light engine shown in FIG. 11, FIG. 13 is a side view of the light engine shown in FIG. 11, FIG. 14 is an end cross sectional view of the light engine shown in FIG. 11, and FIG. 15 is a side cross sectional view of the light engine shown in FIG. 11, in accordance with a second embodiment of the present invention. The remaining components of the second embodiment of the light engine 1108 are similar to those illustrated and described with reference to FIGS. 4 to 10.

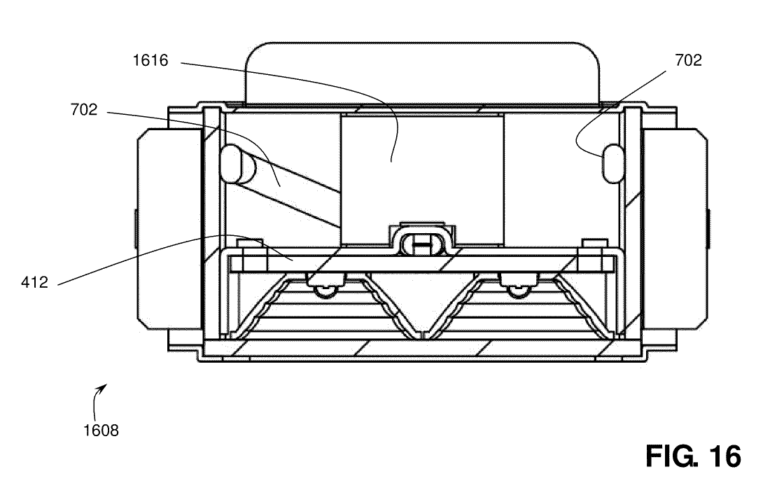

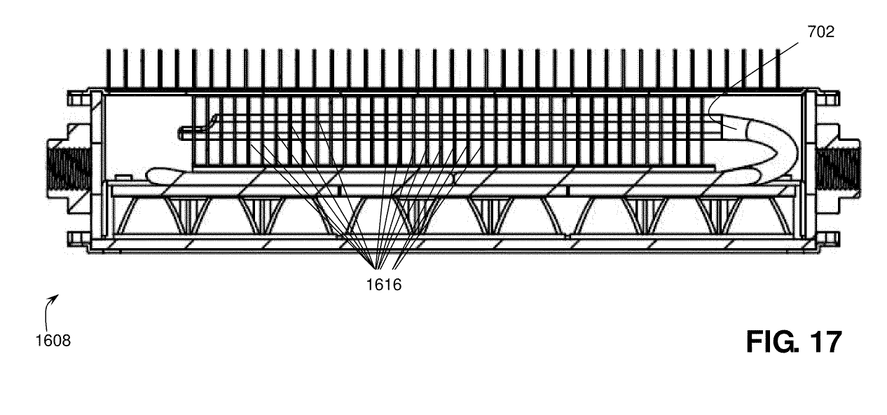

Referring to FIGS. 16 and 17, a third embodiment of the light engine is illustrated and described. FIG. 16 is an end cross sectional view of the third embodiment of the light engine 1608 and FIG. 17 is a side cross sectional view of the light engine shown in FIG. 16, in accordance with an embodiment of the present invention. In the third embodiment of a light engine 1608 shown in FIG. 16, the heat bridge 416 is comprised of multiple internal fins 1616. The multiple internal fins 1616 join the mounting board 412 to the top panel 406. The remaining components of the light engines 1608 are similar to those illustrated and described with reference to FIGS. 4 to 10.

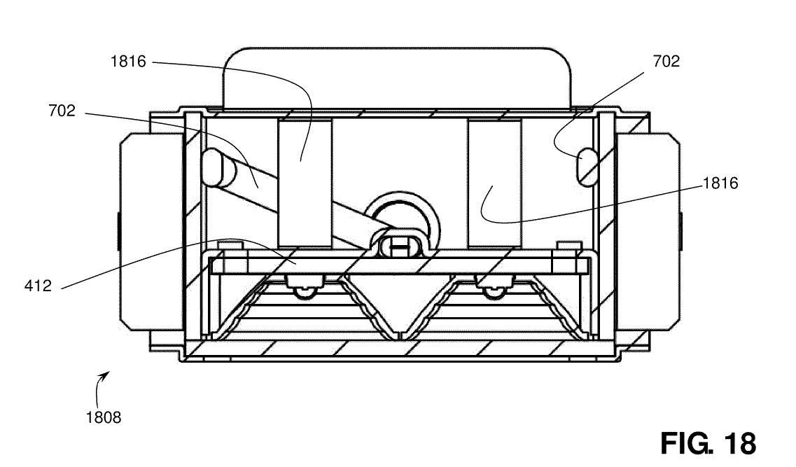

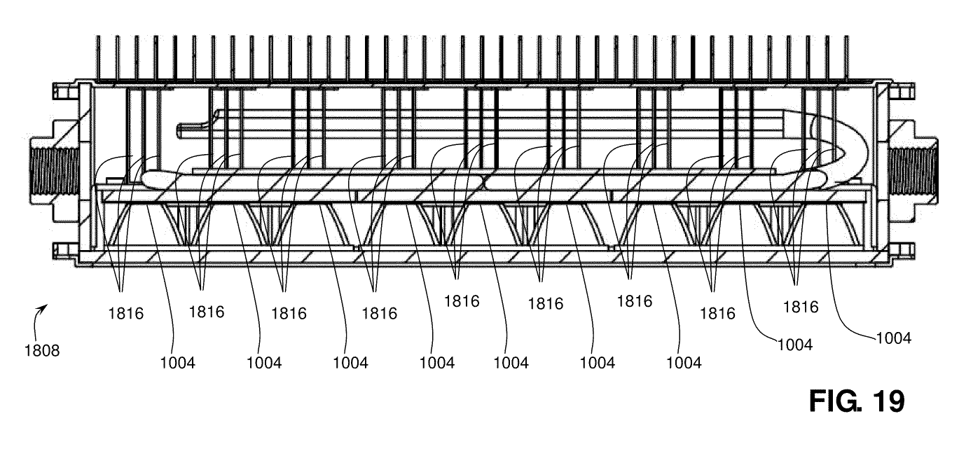

Referring to FIGS. 18 and 19, a fourth embodiment of a light engine is illustrated and described. FIG. 18 is an end cross sectional view of the fourth embodiment of the light engine and FIG. 19 is a side cross sectional view of the light engine shown in FIG. 18, in accordance with an embodiment of the present invention. In the fourth embodiment of the light engine, multiple internal fins 1816 join the mounting board 412 to the top panel 406 as seen in FIG. 19, the multiple internal fins 1816 are arranged in groups, each group of internal fins 1816 positioned proximate to one of the multiple LEDs 1004. In the illustrated embodiment, each of the groups of internal fins 1816 includes three heat dissipation fins. However, any number of fins may be used. The remaining components of the light engines 1808 are similar to those illustrated and described with reference to FIGS. 4 to 10.

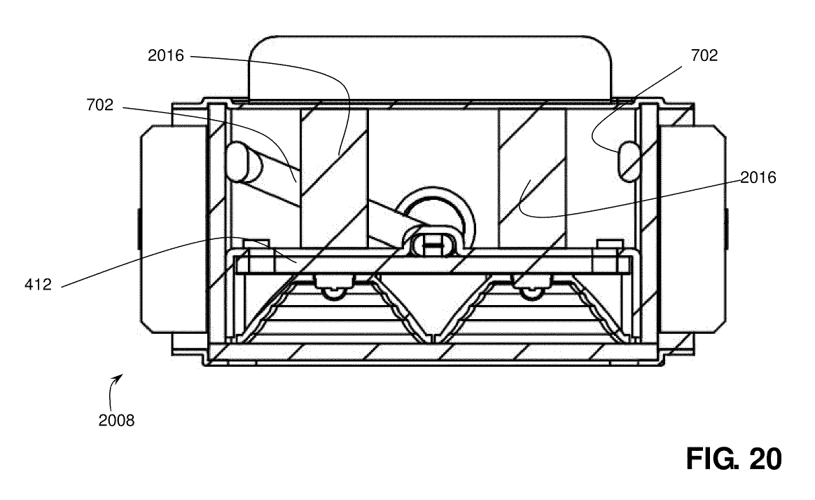

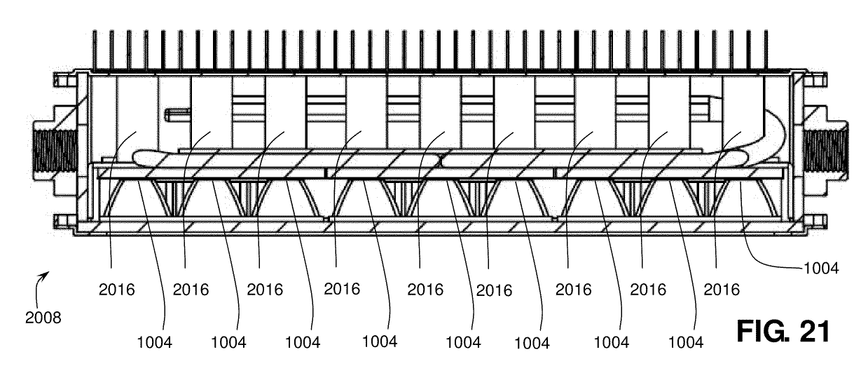

Referring to FIGS. 20 and 21, a fifth embodiment of a light engine is illustrated and described. FIG. 20 is an end cross sectional view of a fifth embodiment of the light engine and FIG. 21 is a side cross sectional view of the light engine shown in FIG. 20, in accordance with an embodiment of the present invention. In the fifth embodiment of the light engine 2008, internal cylinders 2016 join the mounting board 412 to the top panel 406. The internal cylinders 2016 serve as a heat bridge to transfer heat from the mounting board 412 to the top panel 406. As seen in FIG. 21, each of the internal cylinders 2016 is position such that it is generally aligned with one of the multiple LED 1004. The remaining components of the light engines 2008 are similar to those illustrated and described with reference to FIGS. 4 to 10.

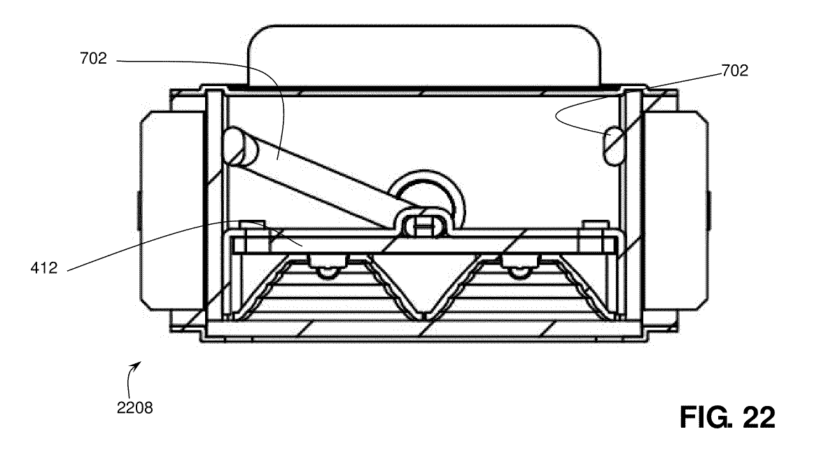

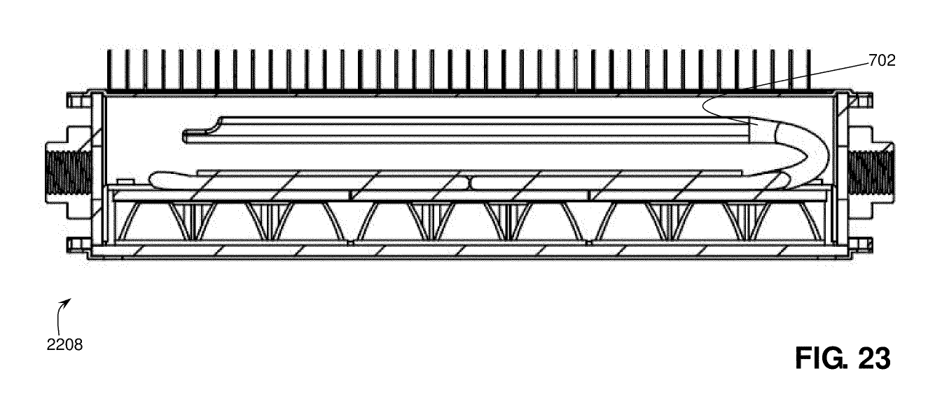

Referring to FIGS. 22 and 23, a sixth embodiment of a light engine is illustrated and described. FIG. 22 is an end cross sectional view of a sixth embodiment of the light engine 2208 and FIG. 23 is a side cross sectional view of the light engine 2208 shown in FIG. 22, in accordance with an embodiment of the present invention. In the sixth embodiment of light engine illustrated in FIG. 22, heat conduction pipes 702 join the mounting board 412 to the side panels 404. In the illustrated embodiment shown in FIGS. 22 and 23, no heat bridge is connected to the top panel 406, thereby resulting in a transfer of greater amount of heat through the heat conduction pipe 702 to the side panels 404. The remaining components of the light engines 2208 are similar to those illustrated and described with reference to FIGS. 4 to 10.

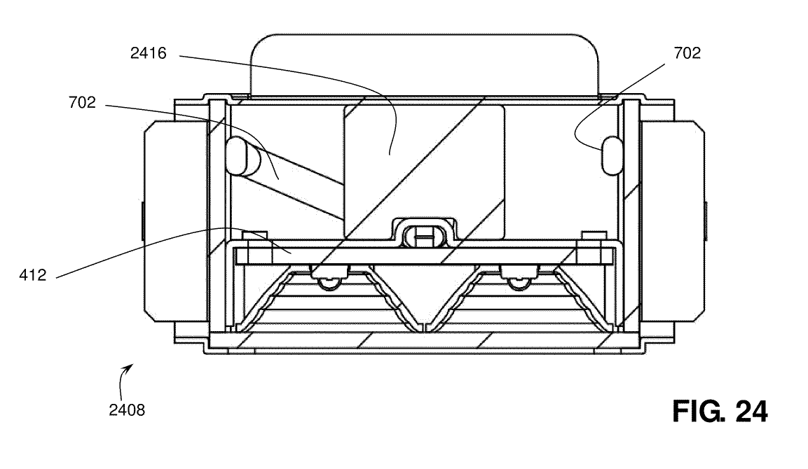

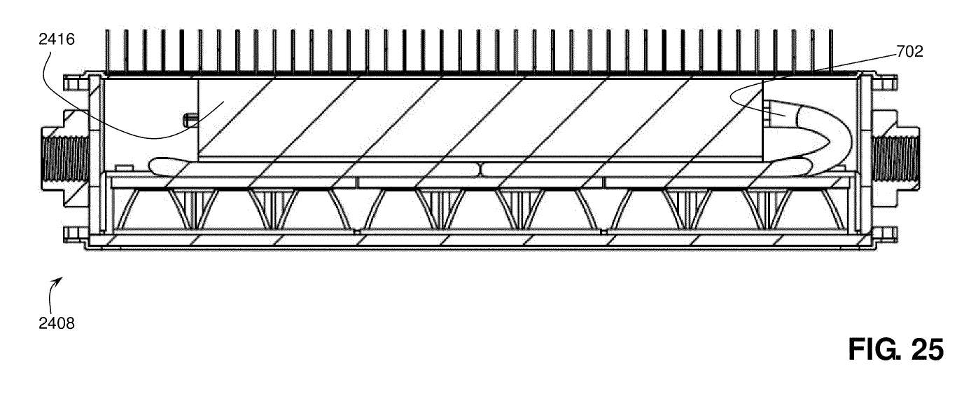

Referring to FIGS. 24 and 25, a seventh embodiment of a light engine is illustrated and described. FIG. 24 is an end cross sectional view of a seventh embodiment of the light engine 2408 and FIG. 25 is a side cross sectional view of the light engine shown in FIG. 24, in accordance with an embodiment of the present invention. In the seventh embodiments of the light engine 2408, an internal metal block 2416 is used as a heat bridge to join the mounting board 412 to the top panel 406. The internal metal block 2416 maybe made from any suitable metal or metal alloy material that is suitable for transferring heat from the mounting board 412 to the top panel 406. The remaining components of the light engines 2408 are similar to those illustrated and described with reference to FIGS. 4 to 10.

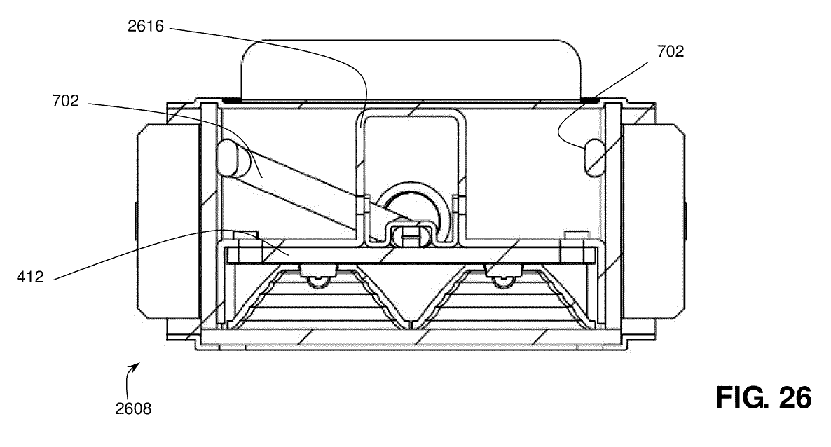

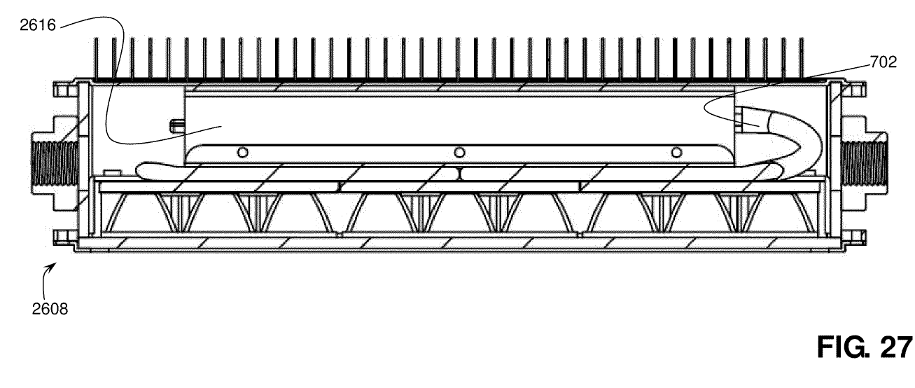

Referring to FIGS. 26 and 27, an eighth embodiment of a light engine is illustrated and described. FIG. 26 is an end cross sectional view of an eighth embodiment of the light engine 2608 and FIG. 27 is a side cross sectional view of the light engine shown in FIG. 26, in accordance with an embodiment of the present invention. In the eighth embodiment of the light engine 2608, a heat conduction board 2616 is used as a heat bridge to join the mounting board 412 to the top panel 406. The heat conduction board 2616 is curved or bent such that a part of heat conduction board 2616 joins the mounting board 412 and a part of the heat conduction board 2616 join the top panel 406. The heat conduction board 2616 may be made from any metal or metal alloy material that sufficiently transfers heat. The remaining components of the light engines 2608 are similar to those illustrated and described with reference to FIGS. 4 to 10.

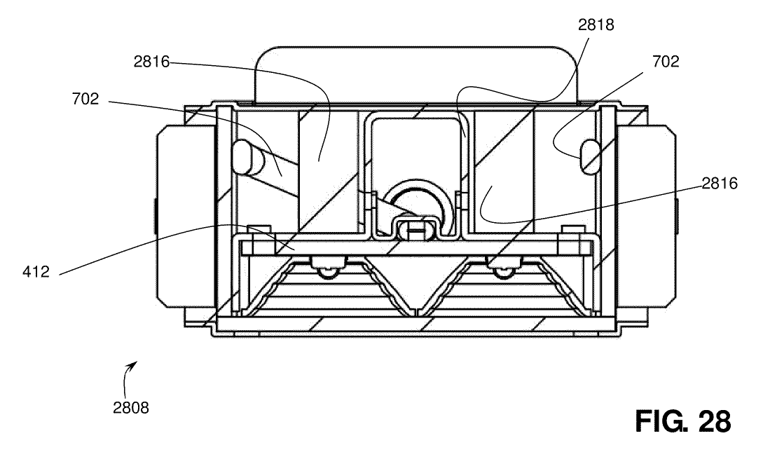

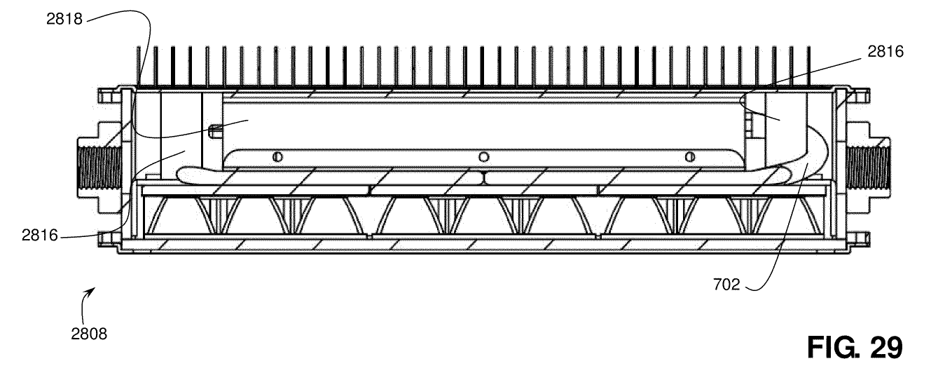

Referring to FIGS. 28 and 29, a ninth embodiment of a light engine is illustrated and described. FIG. 28 is an end cross sectional view of a ninth embodiment of the light engine 2808 and FIG. 29 is a side cross sectional view of the light engine shown in FIG. 28, in accordance with an embodiment of the present invention. In the ninth embodiment of the light engine, a combination of internal cylinders 2816 and a heat conduction board 2818 are both used as a heat bridge to join mounting board 412 and the top panel 406. Heat conduction pipes 702 are also included, joining the mounting board 412 to the side panels 404. The remaining components of the light engines 2808 are similar to those illustrated and described with reference to FIGS. 4 to 10.

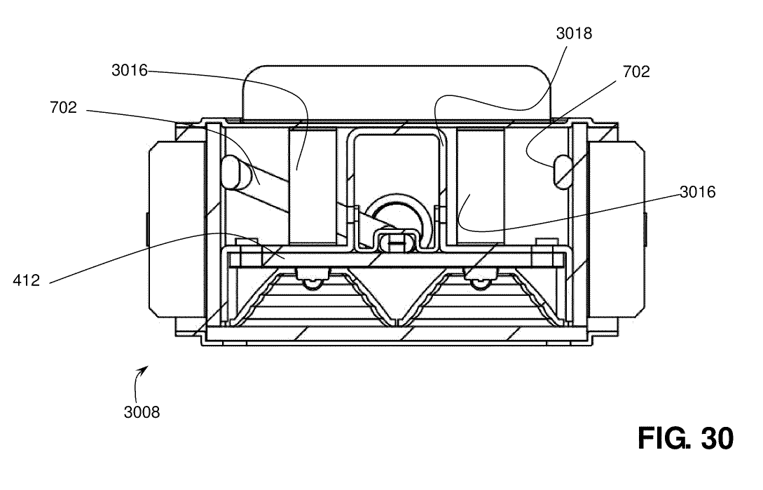

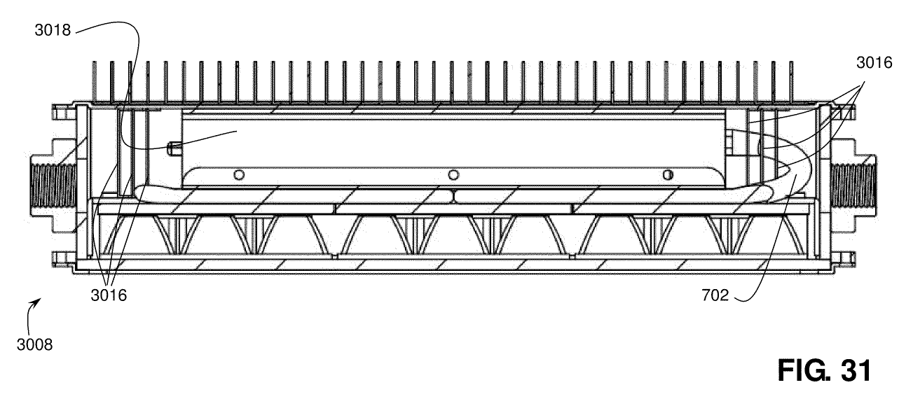

Referring to FIGS. 30 and 31, a tenth embodiment of a light engine is illustrated and described. FIG. 30 is an end cross sectional view of a tenth embodiment of the light engine 3008 and FIG. 31 is a side cross sectional view of the light engine shown in FIG. 30, in accordance with an embodiment of the present invention. In the tenth embodiment of the light engine shown in FIGS. 30 and 31, a combination of internal fins 3016 and a heat conduction board 3018 are used as a heat bridge to join the mounting board 412 to the top panel 406. Heat conduction pipes 702 are also included, joining the mounting board 412 to the side panels 404. The remaining components of the light engines 3008 are similar to those illustrated and described with reference to FIGS. 4 to 10.

In the respective embodiments, the various dissipation pins, the heat conduction pipes, the internal cylinders, the metal block, and the heat conduction board may each be made from any suitable material that dissipates heat. For example, the components may be made from metal or metal alloy material including, for example, aluminum or copper.

While the invention has been particularly shown and described with reference to the illustrated embodiments, those skilled in the art will understand that changes in form and detail may be made without departing from the spirit and scope of the invention. For example, while certain types of materials have been described, other suitable material may also be used. Also, while the specific shape of housings and dissipation plates is illustrated and described, other shapes and configurations may be used without departing from the scope of the present invention. Also, while a specific number of components, such as LEDs internal cylinder, and heat dissipation fins, are shown in the illustrated embodiment, these components may be provided in different shapes and numbers according to the particular implementation.

Accordingly, the above description is intended to provide example embodiments of the present invention, and the scope of the present invention is not to be limited by the specific examples provided.

What is claimed is:

1. A light emitting diode (LED) light engine comprising:
a housing;
an LED mounting board secured within the housing, the LED mounting board including one or more LED electrically connected to the LED mounting board, the LED mounting board configured to receive power from a power source to power the one or more LED; and
a heat bridge conductively coupling the LED mounting board to the housing, wherein the heat bridge is configured to conduct heat from the LED mounting board to the housing, wherein the housing is configured to dissipate heat.

2. The LED light engine of claim 1, wherein the housing further includes a top panel, and wherein the heat bridge includes one or more heat conducting pipes conductively coupling the LED mounting board to the top panel.

3. The LED light engine of claim 1, wherein the housing further includes side panels, and wherein the heat bridge includes one of the one or more heat conducting pipes conductively coupling the LED mounting board to one or more of the side panels.

4. The LED light engine of claim 3, wherein the housing further includes a top panel, and one of the one or more heat conducting pipes conductively couples the LED mounting board to the top panel.

5. The LED light engine of claim 1, wherein the housing further includes side panels and a top panel, and each of the side panels includes multiple heat dissipating fins, the heat dissipating fins configured to dissipate heat into the air.

6. The LED light engine of claim 5, wherein the top panel includes multiple heat dissipating fins, the heat dissipating fins configured to dissipate heat into the air.

7. The LED light engine of claim 1, wherein the housing further includes a top heat sink panel, and wherein the heat bridge includes a heat conducting pipe top panel conductively coupling the LED mounting board to the top panel.

8. The LED light engine of claim 1, wherein the heat bridge includes multiple heat dissipating fins conductively coupling the mounting board to the housing.

9. The LED light engine of claim 8, wherein the multiple heat dissipating fins a grouped into multiple groups of heat dissipating fins, and each of the multiple groups is positioned proximate to one of the one or more LED.

10. The LED light engine of claim 1, wherein the heat bridge includes multiple internal cylinders conductively coupling the mounting board to the housing.

11. The LED light engine of claim 10, wherein each of the multiple internal cylinders is positioned proximate to one of the one or more LED.

12. The LED light engine of claim 1, wherein the heat bridge includes multiple heat dissipating fins conductively coupling the mounting board to the housing.

13. The LED light engine of claim 1, wherein the heat bridge includes a conductive block conductively coupling the mounting board to the housing.

14. The LED light engine of claim 1, wherein the heat bridge includes a conductive plate, wherein the conductive plate is configured such that a first portion of the conductive plate is conductively coupled to the mounting board and a second portion of the conductive plate is conductively coupled to the housing.

15. The LED light engine of claim 1, wherein the housing further includes side panels and a top panel, wherein the heat bridge includes a first heat bridge conductively coupling the mounting board to one or more of the side panels, and the housing further includes a second heat bridge conductively coupling the mounting board to the top panel.

16. The LED light engine of claim 15, wherein the first heat includes one or more heat conducting pipes and the second heat bridge includes multiple internal cylinders.

17. The LED light engine of claim 15, wherein the first heat includes one or more heat conducting pipes and the second heat bridge includes multiple internal heat dissipating fins.

18. An LED lighting assembly comprising:
a lighting assembly housing;
a mounting frame secured within the lighting assembly housing; and multiple LED light engines movably secured to the mounting frame, each of the multiple LED light engines including a housing; an LED mounting board secured within the housing, the LED mounting board including one or more LED electrically connected to the LED mounting board, the LED mounting board configured to receive power from a power source to power the one or more LED; and a heat bridge conductively coupling the LED mounting board to the housing, wherein the heat bridge is configured to conduct heat from the LED mounting board to the housing, wherein the housing is configured to dissipate heat.

19. The LED lighting assembly of claim 18, wherein the housing further includes side panels and a top panel, and each of the side panels includes multiple heat dissipating fins, the heat dissipating fins configured to dissipate heat into the air.

20. The LED lighting assembly of claim 19, wherein the top panel includes multiple heat dissipating fins, the heat dissipating fins configured to dissipate heat into the air.

21. The LED lighting assembly of claim 20, wherein the heat bridge includes a first heat bridge conductively coupling the mounting board to one or more of the side panels, and the housing further includes a second heat bridge conductively coupling the mounting board to the top panel.
